(19) United States
(12) Patent Application Publication
(10) Pub. No.: US 2015/0091935 A1
(43) Pub. Date: Apr. 2, 2015

(54) METHOD AND DEVICE FOR BROWSING WEB UNDER WEAK LIGHT WITH MOBILE TERMINAL BROWSER

(71) Applicant: Tencent Technology (Shenzhen) Company Limited, Shezhen Guangdong (CN)

(72) Inventor: Baohua Zhang, Guangdong (CN)

(21) Appl. No.: 14/566,781

(22) Filed: Dec. 11, 2014

Related U.S. Application Data
(63) Continuation of application No. PCT/CN2013/076915, filed on Jun. 7, 2013.

(30) Foreign Application Priority Data
Jun. 13, 2012 (CN) 201210194386.5

(51) Int. Cl. G09G 5/02; G06F 17/22

(52) U.S. Cl. CPC G09G 5/02; G06F 17/2247
USPC 345/589

(57) ABSTRACT

A method and device for browsing web under weak light with a mobile terminal browser are disclosed by the present invention, which belongs to the field of computer. The method includes: receiving a web uniform resource locator (URL) input by a user, downloading a code of the said web based on said URL; embedding a preset code with a function of changing the color of the page element of the web into the codes of the web page; and executing the preset code to change the color of the page element of the web, thus causing the color contrast of the page element of the web reaching a preset contrast for browsing under the weak light source.

### CROSS REFERENCE TO RELATED APPLICATIONS

The present application is a Continuation application of PCT Patent Application No. PCT/CN2013/076915, filed on Jun. 7, 2013, which claims the benefit of priority to Chinese Patent Application NO. 201210194386.5 filed in the Chinese Patent Office on Jun. 13, 2012 and entitled “METHOD AND DEVICE FOR BROWSING WEB UNDER WEAK LIGHT WITH MOBILE TERMINAL BROWSER”, the contents of which are hereby incorporated by reference in their entireties for all purposes.

### FIELD OF THE TECHNICAL

The disclosure relates to a field of computer technologies, and particularly to a method and device for browsing web under weak light with a mobile terminal browser.

### BACKGROUND

With the development of network, demand for browsing web pages is growing. Browsers are installed in all kinds of mobile terminals. With the development of the browsers installed in the mobile terminals, more and more functions of the browsers are humanizing to meet various demands of users. For example, one of the functions of the browsers is a night browsing mode, which enables the users to browse the web user-friendly under weak light with the browser.

Generally, color contrast between page elements of the web page need to be improved to make the users watch contents of the web page clearer. However, in the night or in low light, a screen of the mobile terminal with the higher color contrast is dazzling. Therefore, a browser with the night browsing mode is created. The browser has a function of browsing the web under the weak light. At the night browsing mode, the color contrast between the page elements can be decreased, to avoid the screen of the mobile terminal with the night browsing mode dazzling.

In the existing browsers, in order to browse the web under the weak light with the browser, codes are applied to change underlying codes of the browser. That is, a fixed color value is written into the underlying codes of the browser, to change the color contrast between the page elements. However, this way of changing the underlying codes of the browser to realize browsing the web under the weak light may make the logic of kernel-level codes of the browser more complicated, so that the kernel-level codes cannot be maintained.

### SUMMARY

In order to solve questions of existing technology, exemplary embodiments of the present invention provide a method and device for browsing web under weak light with mobile terminal browser. Technical solutions are follows.

One embodiment of the present invention provides a method for browsing the web under weak light with a mobile terminal browser. The method includes:

receiving a uniform resource locator (URL), input by a user, of a web page, and downloading codes of the web page according to the URL;

embedding a predetermined code into the codes of the web page, wherein the predetermined code has a function of changing colors of page elements of the web page;

executing the predetermined code to change the colors of the page elements of the web page, to make color contrast between the page elements of the web page be equal to a predetermined contrast, wherein the web page with the predetermined contrast is suitable for being browsed under the weak light.

Further, before embedding a predetermined code into the codes of the web page, the method further includes:

rendering the web page in a page display area of the browser according to the codes of the web page.

Further, the step of embedding a predetermined code into the codes of the web page includes:

determining whether a notification indicating that the web page has been rendered is received; and

triggering to execute the operation of the predetermined code if a notification indicating that the web page has been rendered is received.

Further, the step of executing the predetermined code to change the colors of the page elements of the web page includes:

obtaining the color attributes of the page elements of the web page one by one, and resetting the color attributes of the page elements of the web page until the all page elements of the web page are been reset.

Further, the step of resetting the color attributes of the page elements of the web page includes:

obtaining foreground color attributes of the page elements, and setting color values of the foreground color attributes between a value 0XFFFFFF and a value 0x808080; and

obtaining background color attributes of the page elements, and setting color values of the background color attributes between a value 0x000000 and a value 0x808080.

Another embodiment of the present invention provides device for browsing the web under weak light with a mobile terminal browser, comprising:

a downloading module configured to receive a uniform resource locator (URL), input by a user, of a web page, and download codes of the web page according to the URL;

an embedding module configured to embed a predetermined code into the codes of the web page, wherein the predetermined code has a function of changing colors of page elements of the web page; and

a changing module configured to execute the predetermined code to change the colors of the page elements of the web page, to make color contrast between the page elements of the web page be equal to a predetermined contrast, wherein the web page with the predetermined contrast is suitable for being browsed under the weak light.

Further, the device further includes:

a rendering module configured to render the web page in a page display area of the browser according to the codes of the web page before the embedding module embeds the predetermined code into the codes of the web page.

Further, the embedding module includes:

a determination unit configured to determine whether a notification indicating that the web page has been rendered is received; and

a triggering unit configured to trigger to execute the predetermined code when the determination unit determines that the web page has been rendered is received.

Further, the changing module is further configured to obtain the original color attributes of the page elements of the web page one by one, and reset the original color attributes of the page elements of the web page until the original color attributes of the all page elements of the web page are reset.

Further, the changing module further comprises:

an obtaining unit configured to obtain the color attributes of the page elements of the web page one by one;

a first changing unit configured to obtain the foreground color attributes of the page elements, and setting color values of the foreground color attributes between a value 0XFFFFFF and a value 0x808080; and

a second changing unit configured to obtain the background color attributes of the page elements, and setting color values of the background color attributes between a value 0x000000 and a value 0x808080.

Yet another embodiment of the present invention provides a terminal. The terminal includes:

a storage;

one or more programs stored in the storage for execution by one or more processors, the one or more programs comprising instructions for:

receiving a uniform resource locator (URL), input by a user, of a web page, and downloading codes of the web page according to the URL;

embedding a predetermined code into the codes of the web page, wherein the predetermined code has a function of changing colors of page elements of the web page;

executing the predetermined code to change the colors of the page elements of the web page, to make color contrast between the page elements of the web page be equal to a predetermined contrast, wherein the web page with the predetermined contrast is suitable for being browsed under the weak light.

Further, before embedding a predetermined code into the codes of the web page, the method further includes:

rendering the web page in a page display area of the browser according to the codes of the web page.

Further, the step of embedding a predetermined code into the codes of the web page includes:

determining whether a notification indicating that the web page has been rendered is received; and

triggering to execute the operation of the predetermined code if a notification indicating that the web page has been rendered is received.

Further, the step of executing the predetermined code to change the colors of the page elements of the web page includes:

obtaining the color attributes of the page elements of the web page one by one, and resetting the color attributes of the page elements of the web page until the all page elements of the web page are been reset.

Further, the step of resetting the color attributes of the page elements of the web page includes:

obtaining foreground color attributes of the page elements, and setting color values of the foreground color attributes between a value 0XFFFFFF and a value 0x808080; and

obtaining background color attributes of the page elements, and setting color values of the background color attributes between a value 0x000000 and a value 0x808080.

Yet another embodiment of the present invention provides a non-transitory computer readable storage medium, storing one or more programs for execution by one or more processors of a computer having a display, the one or more programs comprising instructions for:

receiving a uniform resource locator (URL), input by a user, of a web page, and downloading codes of the web page according to the URL;

embedding a predetermined code into the codes of the web page, wherein the predetermined code has a function of changing colors of page elements of the web page;

executing the predetermined code to change the colors of the page elements of the web page, to make color contrast between the page elements of the web page be equal to a predetermined contrast, wherein the web page with the predetermined contrast is suitable for being browsed under the weak light.

Further, before embedding a predetermined code into the codes of the web page, the method further includes:

rendering the web page in a page display area of the browser according to the codes of the web page.

Further, the step of embedding a predetermined code into the codes of the web page includes:

determining whether a notification indicating that the web page has been rendered is received; and

triggering to execute the operation of the predetermined code if a notification indicating that the web page has been rendered is received.

Further, the step of executing the predetermined code to change the colors of the page elements of the web page includes:

obtaining the color attributes of the page elements of the web page one by one, and resetting the color attributes of the page elements of the web page until the all page elements of the web page are been reset.

Further, the step of resetting the color attributes of the page elements of the web page includes:

obtaining foreground color attributes of the page elements, and setting color values of the foreground color attributes between a value 0XFFFFFF and a value 0x808080; and obtaining background color attributes of the page elements, and setting color values of the background color attributes between a value 0x000000 and a value 0x808080.

The Technical solutions provided by the above-mentioned embodiments brings the following beneficial effects: the color matching of the page elements of the web page can be adjusted through embedding the predetermined code with a function of changing the color of the page element into the codes of the web page, after downloading the codes of the web page visited by the user. The color matching of the page element is adjusted to be a new color matching with a low contrast, which is suitable for being browsed under the weak light. The method solves the problem at business layer, thus makes architecture of the browser clearer. Therefore, it is easier to maintain the browser.

### BRIEF DESCRIPTION OF THE DRAWINGS

In order to illustrate the embodiments or existing technical solutions more clearly, a brief description of drawings that assist the description of embodiments of the invention or existing art will be provided below. It would be apparent that the drawings in the following description are only for some of the embodiments of the invention. A person having ordinary skills in the art will be able to obtain other drawings on the basis of these drawings without paying any creative work.

FIG. 1 is a flowchart of a method for browsing the web page under weak light with a mobile terminal browser according to a first embodiment one of the present invention;

FIG. 2 is a flowchart of a method for browsing the web page under weak light with a mobile terminal browser according to a second embodiment of the present invention;

FIG. 3 is a first structural diagram of a device for browsing the web page under weak light with a mobile terminal browser according to a third embodiment of the present invention;

FIG. 4 is a second structural diagram of a device for browsing the web page under weak light with a mobile terminal browser according to the third embodiment of the present invention;

FIG. 5 is a structural diagram of an embedding module of the device for browsing the web page under weak light with a mobile terminal browser according to the third embodiment of the present invention;

FIG. 6 is a structural diagram of a changing module of the device for browsing the web page under weak light with a mobile terminal browser according to the third embodiment of the present invention;

FIG. 7 is a first structural diagram of a terminal according to a fourth embodiment of the present invention;

FIG. 8 is a second structural diagram of a terminal according to the fourth embodiment of the present invention.

### DETAILED DESCRIPTION OF ILLUSTRATED EMBODIMENTS

The present invention is herein after described further in detail with reference to the accompanying drawings so as to make the objective, technical solution, and merits of exemplary embodiments more apparent. The term “exemplary” used throughout this description means “serving as an example, instance, or illustration,” and should not necessarily be construed as preferred or advantageous over other exemplary embodiments. It would be apparent that a person having ordinary skills in the art may obtain other embodiments based on the illustrated exemplary embodiments of the invention without paying any creative work, and these embodiments should also be within the protection scope sought by the present invention.

### A First Embodiment

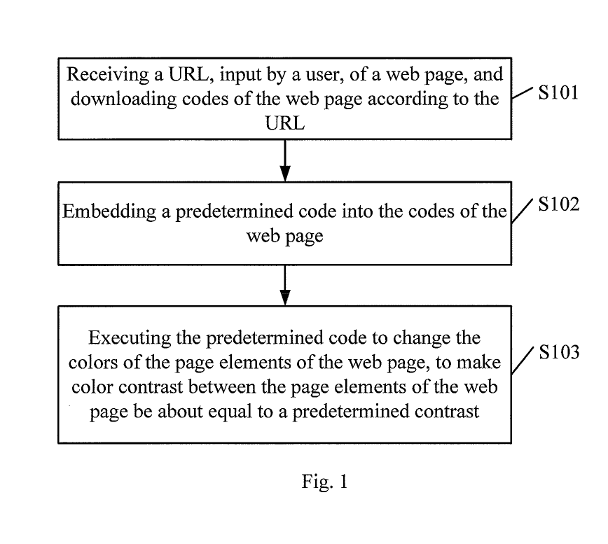

Referring to FIG. 1, the embodiment provides a method for browsing the web under weak light with a mobile terminal browser. The method at least includes the following steps.

Step 101, receiving a uniform resource locator (URL), input by a user, of a web page, and downloading codes of the web page according to the URL.

Step 102, embedding a predetermined code into the codes of the web page.

Specifically, the predetermined code has a function of changing colors of page elements of the web page.

Step 103, executing the predetermined code to change the colors of the page elements of the web page, to make color contrast between the page elements of the web page equate a predetermined contrast. The web page with the predetermined contrast is suitable for being browsed under the weak light.

The embodiment provides the method for browsing the web under the weak light with the mobile terminal browser. The method can adjust the color matching of the page elements of the web page through embedding the predetermined code with a function of changing the colors of the page elements into the codes of the web page, after downloading the codes of the web page visited by the user. The color matching of the page elements is adjusted to be a new color matching with a low contrast, which is suitable for browsing the web page under the weak light. The method solves the problem at business layer, thus making architecture of the browser clearer. Therefore, it is easier to maintain the browser.

### A Second Embodiment

The embodiment provides a method for browsing the web under the weak light with the mobile terminal browser. The method can be applied to the browser of the mobile terminal, to enable the browser to support a function of browsing the web under the weak light.

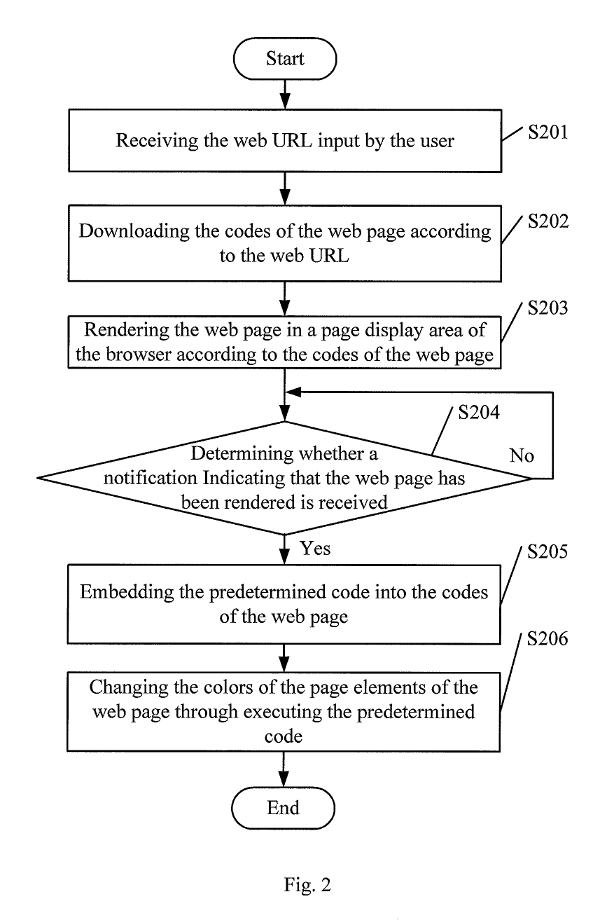

Referring to FIG. 2, under a condition of starting the function of browsing the web under the weak light of the browser by the user, the method includes the following steps.

Step 201, receiving the web URL input by the user.

Specifically, the browser resolves a domain name according to the web URL, and initiates a request to a server corresponding to the web URL to get codes of the web page.

Step 202, downloading the codes of the web page according to the web URL.

Specifically, the codes of the web page may be defined as hypertext markup language (HTML) codes. The HTML codes indicate attributes of the all page elements of the web page. The attribute of each page element may include a location, a color, and a detail content of each page element.

Specifically, the codes of the web page further include javascript codes, cascading style sheet (CSS) codes, image links, and so on.

Step 203, rendering the web page in a page display area of the browser according to the codes of the web page.

Further, the step of rendering the web in a page display area of the browser according to the codes of the web page may be defined as:

the browser parses the codes of the web page to get a document object model (DOM) tree, and a web is consist of the page elements of the web page rendered in the display area of the browser according to the DOM tree.

Specifically, the attribute of each page element is stored in the DOM tree.

Step 204, determining whether a notification indicating that the web page has been rendered is received, if the notification is received, the step 205 is preformed. If the notification fails to be received, the step 204 is still preformed.

It should be noted that when the web page has been rendered in the display area of the browser, the notification is fed back to the browser. In the embodiment, the notification is monitored and the notification is defined as a triggering incident that the predetermined code is embedded into the codes of the web page.

Step 205, embedding the predetermined code into the codes of the web page.

Specifically, the predetermined code has a function of changing the color of the page elements of the web page. After receiving the notification indicating that the web page has been rendered, an address of the web page being accessed is pointed to an address of the predetermined code, to change the codes of the colors of the page elements of the web page through executing the predetermined code.

Step 206, changing the colors of the page elements of the web page through executing the predetermined code.

Specifically, the step of changing the colors of the page elements of the web page through executing the predetermined code may be defined as:

obtaining the color attributes of the page elements of the web page one by one, and resetting the color attributes of the page elements of the web page until the all page elements of the web page are been reset.

Further, resetting the color attributes of the page elements may include the following steps.

Obtaining foreground color attributes of the page elements, and setting color values of the foreground color attributes between a value 0XFFFFFF and a value 0x808080.

Obtaining background color attributes of the page elements, and setting color values of the background color attributes between a value 0x000000 and a value 0x808080.

Through above-mentioned changing the color attributes of the page elements of the web page, the color contrast between the page elements of the web page may be equal to the predetermined contrast, to be suitable for browsing the web page in the night.

Further, in the JavaScript, a value from the value 0xFFFFFF to the value 0x808080 denotes white with brightness. From the value 0xFFFFFF to the value 0x808080, the brightness of the white is decreasing. A value from the value 0x000000 to the value 0x808080 denotes black with brightness. From the value 0x000000 to the value 0x808080, the brightness of the black is increasing.

For the description, the embodiment provides the following JavaScript codes used to be as the codes with the function of changing the color of the page element of the web page to illustrate:

for (i=0; i<document.all.length; i++);

{
document.all[i].style.color=“#808080”;
document.all[i].style.bgcolor=“#000000”;
document.all[i].style.backgroundColor=“#000000”;

}

In the above-mentioned codes, i denotes that the ith page element of the all page elements of the current web page; document.all.length denotes that the number of the all page elements of the current web page; document.all[i].style.color denotes that the foreground color attribute of the ith page element; each of document.all[i].style.bgcolor and document.all[i].style.backgroundColor denotes the background color of the ith page element. The style.bgcolor is used to set the background color of the P element, such as the background color of a word paragraph. The style.backgroundColor is used to set a background color of a button, and an edit box of the web page.

In the specific embodiment, by way of loop through, the color values of the background color attribute and the foreground color attribute of each page element of the web page are adjusted.

In the embodiment, the document.all[i].style.color can be set as “#808080”, that is, the foreground color of the words is the white with the 50% brightness. The document.all[i].style.bgcolor and the document.all[i]styple.backgroundColor both are set as “#000000”, that is, the background of the current web page is black, the words of the current web page is white, to facilitate the users to browse the current web page in the night.

Further, after executing the above-mentioned codes, the color attributes of the page elements corresponding to the DOM tree got by parsing the HTML code are changed. The changed color attributes are recoded in the DOM tree to replace the original color attributes of the page elements to form a new DOM tree. The browser refreshes the current web according to the new DOM tree, that is, the browser renders the web page again according to the new DOM tree, to form a new web page with the changed color attributes, and display the new web page.

It should be noted that the time from rendering the web in the page display area of the browser according to the codes of the web page of the step 203 to refresh the current web page is too short, so that the user cannot find it.

The embodiment provides the method for browsing the web under the weak light with the mobile terminal browser. The method can adjust the color matching of the page elements of the web page through embedding the predetermined code with a function of changing the colors of the page elements into the codes of the web page, after downloading the codes of the web page visited by the user. The color matching of the page elements is adjusted to be a new color matching with a low contrast, which is suitable for browsing the web page under the weak light. The method solves the problem at business layer, thus making architecture of the browser clearer. Therefore, it is easier to maintain the browser.

### A Third Embodiment

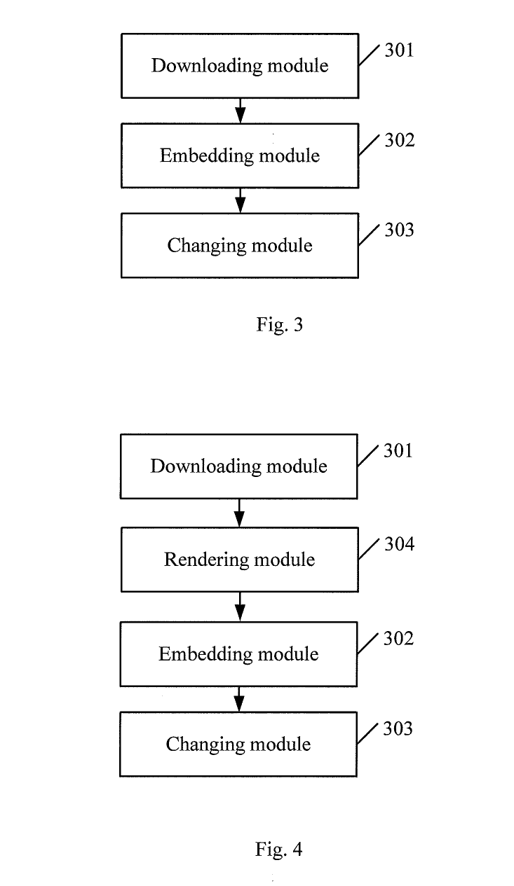

Referring to FIG. 3, the embodiment provides a device for browsing the web under weak light with a mobile terminal browser. The device includes a downloading module 301, an embedding module 302, and a changing module 303.

The downloading module 301 is used to receive a uniform resource locator (URL), input by a user, of a web page, and download codes of the web page according to the URL.

The embedding module 302 is used to embed a predetermined code into the codes of the web page. The predetermined code has a function of changing colors of page elements of the web page.

The changing module 303 is used to execute the predetermined code to change the colors of the page elements of the web page, to make color contrast between the page elements of the web page equate a predetermined contrast. The web page with the predetermined contrast is suitable for being browsed under the weak light.

Further, referring to FIG. 4, the device further includes a rendering module 304.

The rendering module 304 is used to render the web page in a page display area of the browser according to the codes of the web page before the embedding module 302 embeds the predetermined code into the codes of the web page.

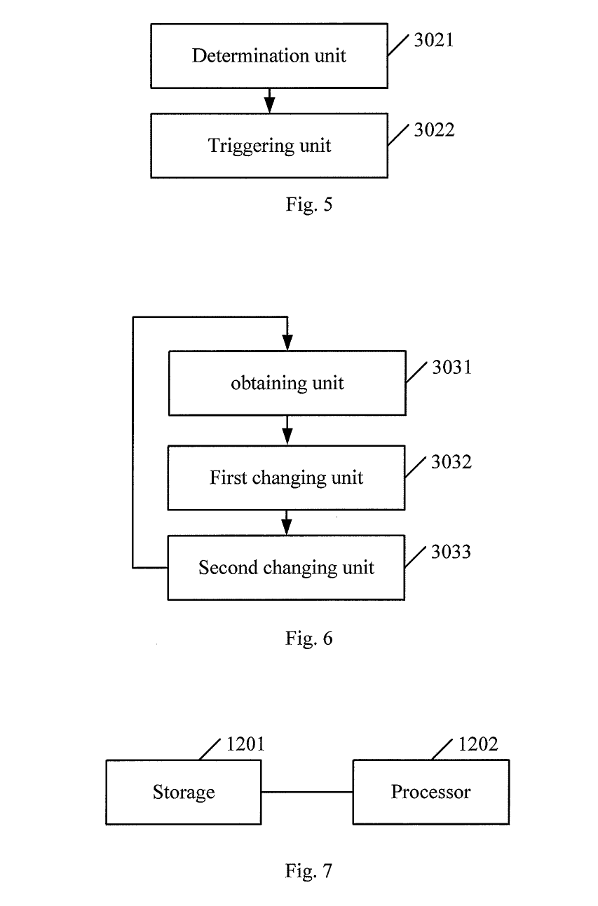

Further, referring to FIG. 5, the embedding module 302 includes a determination unit 3021 and a triggering unit 3022.

The determination unit 3021 is used to determine whether a notification indicating that the web page has been rendered is received.

The triggering unit 3022 is used to trigger to execute the predetermined code when the determination unit 3021 determines that the web page has been rendered is received.

Further, the changing module 303 is used to obtain the original color attributes of the page elements of the web page one by one, and resets the original color attributes of the page elements of the web page until the original color attributes of the all page elements of the web page are reset.

Further, referring to FIG. 6, the changing module 303 includes an obtaining unit 3031, a first changing unit 3032, and a second changing unit 3033.

The obtaining unit 3031 is used to obtain the color attributes of the page elements of the web page one by one.

The first changing unit 3032 is used to obtain the foreground color attributes of the page elements, and setting color values of the foreground color attributes between a value 0XFFFFFF and a value 0x808080.

The second changing unit 3033 is used to obtain the background color attributes of the page elements, and setting color values of the background color attributes between a value 0x000000 and a value 0x808080.

The embodiment provides the device for browsing the web under the weak light with the mobile terminal browser. The device can adjust the color matching of the page elements of the web page through embedding the predetermined code with a function of changing the colors of the page elements into the codes of the web page, after downloading the codes of the web page visited by the user. The color matching of the page elements is adjusted to be a new color matching with a low contrast, which is suitable for browsing the web page under the weak light. The method solves the problem at business layer, thus making architecture of the browser clearer. Therefore, it is easier to maintain the browser.

It should be noted that when the device provided in the above-mentioned embodiments browses the web page under the weak light with the mobile terminal browser, the above-mentioned function modules and units are taken as an example to illustrate. In practice, the above-mentioned functions can be assigned to the different function modules or units to execute. That is, the structure of the device is divided into different function modules, to realize all or parts of the above-mentioned functions. In addition, the above-mentioned method for browsing the web under the weak light with the mobile terminal browser and the device for browsing the web under the weak light with the mobile terminal browser belongs to the same conception.

### A Fourth Embodiment

Referring to FIG. 7, the embodiment provides a terminal 1200. The terminal 1200 may include a storage 1201 and at least one processor 1202. The storage 1201 stores software programs and modules (such as the instructions and modules corresponding to the browser in the embodiment), and data which is generated during the process of browsing the web page under the weak light by the mobile terminal browser. The processor 1202 can execute varieties of function applications and process data by running the software programs and modules stored in the storage 1201, which realizes the function of safety protection.

Specifically, the processor 1202 is configured to execute the following operations for browsing the web under weak light with a mobile terminal browser:

receiving a uniform resource locator (URL), input by a user, of a web page, and downloading codes of the web page according to the URL.

embedding a predetermined code into the codes of the web page, the predetermined code has a function of changing colors of page elements of the web page.

executing the predetermined code to change the colors of the page elements of the web page, to make color contrast between the page elements of the web page equate a predetermined contrast. The web page with the predetermined contrast is suitable for being browsed under the weak light.

Specifically, before the step of embedding a predetermined code into the codes of the web page, the method further includes:

rendering the web page in a page display area of the browser according to the codes of the web page.

Specifically, the step of embedding a predetermined code into the codes of the web page includes:

determining whether a notification indicating that the web page has been rendered is received; if the notification is received, trigging to execute the predetermined code.

Specifically, the step of executing the predetermined code to change the colors of the page elements of the web page includes:

obtaining the original color attributes of the page elements of the web page one by one; and resetting the original color attributes of the page elements of the web page until the original color attributes of the all page elements of the web page are reset.

Specifically, the step of resetting the original color attributes of the page elements of the web page includes:

obtaining the foreground color attributes of the page elements, and setting color values of the foreground color attributes between a value 0XFFFFFF and a value 0x808080;

obtaining the background color attributes of the page elements, and setting color values of the background color attributes between a value 0x000000 and a value 0x808080.

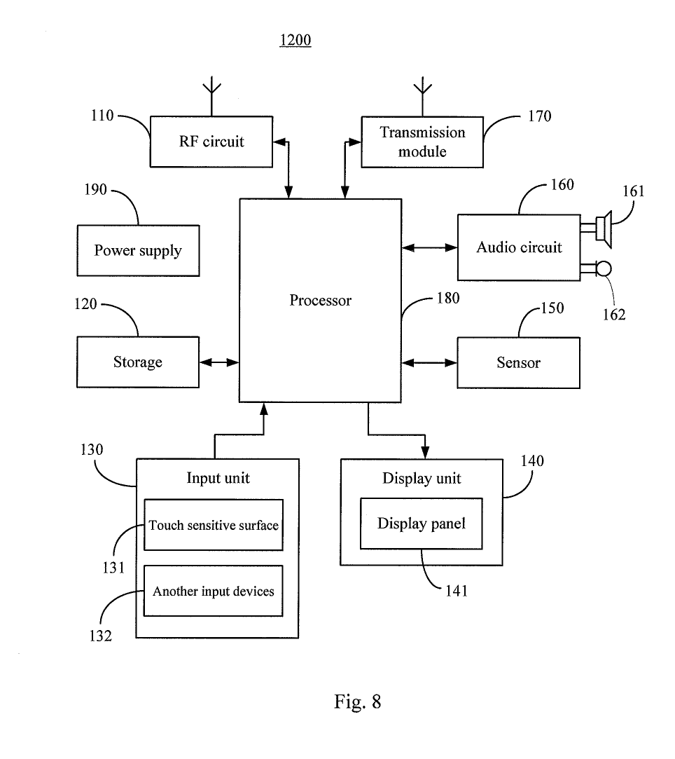

Preferably, referring to FIG. 8, the terminal 1200 further includes: a radio frequency (RF) circuit 110, one or more than one storage 120 with computer readable storage medium, an input unit 130, a display unit 140, a sensor 150, an audio circuit 160, a transmission module 170, one or more than one processors 180, and a power supply 190.

Person having ordinary skill in the art can understand that the structure of the terminal shown in the FIG. 7 cannot limit the terminal. That is, the terminal may includes more than or less than the elements shown in the FIG. 7, or combinations of the elements shown in the FIG. 7. The terminal may have other element arrangement which is different from the element arrangement shown in the FIG. 7.

The RF circuit 110 is used to receive and send information, or receive and send signals during a communication. Specially, the RF circuit 110 receives downlink information from a base station, and then sends the downlink information to one or more than one processor 180 to be processed. In addition, the RF circuit 110 also sends uplink data corresponding to the downlink information to the base station. Generally, the RF circuit 110 includes but is not limited to: an antenna, at least one amplifier, a tuner, one or more than one oscillator, a subscriber identity module (SIM) card, a transceiver, a coupler, a low noise amplifier (LNA), and a duplexer. In addition, the RF circuit 100 may conduct wireless communication with network and other devices. The wireless communication may use any communication standard or communication protocol, which includes but is not limited to a global system of mobile communication (GSM), a general packet radio service (GPRS), a code division multiple access (CDMA), a wideband code division multiple access (WCDMA), long term evolution (LTE), an email, a short messaging service (SMS).

The storage 120 may be used to store software programs and modules, such as the program instructions and modules corresponding to the browser of the above-mentioned embodiments, and store data generated during a process of the mobile terminal browser browsing the web page under the weak light in the embodiment. The processor 180 can run the software programs and the modules stored in the storage 120 to execute the corresponding function applications and process the corresponding data, thus realizing the function of browsing the web page under the weak light with the mobile terminal browser. The storage 120 may mainly include a program storage area and a data storage area. The program storage area can store an operation system, at least one application program corresponding to one function (such as, a sound play function, an image play function, and so on). The data storage area can store data (such as audio data, phone book, and so on) created by the use of the terminal 1200. In addition, the storage 120 may include a high-speed random access memory and a nonvolatile memory, such as at least one disk storage device, flash memory device, or other volatile solid state memory device. Correspondingly, the storage 120 may further include a controller, to control the processor 180 and the input unit 130 to access the storage 120.

The input unit 130 may be used to receive input number or character information, and also used to be as a keyboard, a mouse, an operation rob, an optical input device or a trackball signal input device to conduct the user setup or function control. In detail, the input terminal 130 may include a touch sensitive surface 131 and an input device 132. The touch sensitive surface 131 may be defined as a touch screen panel or a touchpad, which is used to receive an instruction generated by a touch operation on or around the touch sensitive surface 131, and drives a connection device corresponding to the instruction according to a predetermined program. The touch operation may be an operation of an object (such as a figure or a stylus) moving on or around the touch sensitive surface 131. Preferably, the touch sensitive surface 131 may include a touch detection device and a touch controller. The touch detection device detects a location of the user touching the touch sensitive surface 131, and detects a signal generated by touch operation, and transmits the signal to the touch controller. The touch controller receives the signal from the touch detection device, and converts the signal into a coordinate, and transmits the coordinate to the processor 180. The touch controller can receive an instruction from the processor 180 and execute the instruction. In addition, the touch sensitive surface 131 may be a resistive touch screen panel or touchpad, a capacitive touch screen panel or touchpad, an infrared touch screen panel or touchpad, a surface acoustic wave touch screen panel or touchpad, or other types touch screen panels or touch pads. The input unit 130 further includes other input devices 132. The other input devices 132 may include but not be limited to one or more of a physical keyboard, function keys (such as a volume key for controlling the volume of the terminal, a switch key, and so on), a trackball, a mouse, an operation rob, and so on.

The display unit 140 may be used to display information input by the user or supplied to the user, and display all kinds of graphical user interfaces (GUIs) of the terminal 1200. The GUIs may consist of graphs, texts, icons, videos, and any combination of the graphs, the texts, the icons, and the videos. The display unit 140 may include a display panel 141. The display panel 141 may be the liquid crystal display (LCD) panel or the organic light-emitting diode panel. Further, the touch sensitive surface 131 can cover the display panel 141. When the touch sensitive surface 131 detects the touch operation on or around the touch sensitive surface 131, the touch sensitive surface 131 transmits the instruction corresponding to the touch operation to the processor 180, to make the processor 180 determine a type of the touch operation. After the processor 180 determines the type of the touch operation, the processor 180 displays the determined type of the touch operation on the display panel 141. Although the touch sensitive surface 131 and the display panel 141 are two independent elements to respectively realize the input function and the output function in FIG. 8, in some embodiments, the touch sensitive surface 131 is integrated with the display panel 141 to realize the input function and the output function.

The terminal 1200 further may include at least one sensor 150, such as a light sensor, a motion sensor, and other sensors. In detail, the light sensor may include an ambient light sensor and a proximity sensor. The ambient light sensor can adjust the brightness of the display panel 141 according to the ambient light. The proximity sensor can turn off the display panel 141 and/or backlight when the terminal 1200 moves to the ear of the user. As one of the motion sensors, a gravity sensor can detect accelerations from every direction (generally the directions of three axles), and detect the gravity and a direction of the gravity. The gravity sensor also can determine special applications of a mobile phone (such as a switch from a landscape mode of the mobile phone to a portrait mode, games related to the pose of the mobile phone, a magnetometer pose calibration), and detects functions related to vibration (such as pedometer, knock). The terminal 1200 also has a gyroscope, a barometer, a hygrometer, a hygrometer, a thermometer, an infrared sensor, and so on.

Each of an audio circuit 160, a loudspeaker 161, and a microphone 162 has an audio interface to be supplied for the user. The audio circuit 160 may receive audio data and converts the audio data into an electrical signal, and transmit the electrical signal to the loudspeaker 160. The loudspeaker 160 converts the electrical signal into a sound signal, and outputs the sound signal. In addition, the loudspeaker 162 can receive a sound signal, converts the sound signal into an electrical signal, and outputs the electrical signal to the audio circuit 160. The audio circuit 160 receives the electrical signal, converts the electrical signal into an audio signal, and outputs the audio signal to the processor 180. The processor 180 processes the audio signal and outputs the processed audio signal to another terminal by RF circuit 110, or stores the processed audio signal in the storage 120. The audio circuit 160 may include a headphone jack, to connect to an external headphone to make the external headphone communicate with the terminal 1200.

The WIFI belongs to a short-range wireless communication technology. The terminal 1200 can help the user to receive or send email, browse the web pages and access to the streaming media through an input/output interface of the WIFI module. The terminal 1200 provides the wireless network to make the user can access the internet. Although there is the WIFI module 170 in FIG. 8, it can be understood that the terminal 1200 may not include the WIFI module 170. That is, the WIFI module 170 of the terminal 1200 can be omitted according to need.

The processor 180 is a control center of the terminal 1200, and is connected to every portion of the mobile phone through all kinds of interfaces and cables. The processor 180 executes various functions and processes data of the terminal 1200 to monitor the mobile phone through running or executing the software programs and/or modules stored in the storage 120, or through invoking data stored in the storage 120. The processor 180 may include one processing core or more processing cores. Preferably, an application processor and a modem processor can be integrated into the processor 180. The application processor mainly processes the operation system, the user interface, application programs, and so on. The modem processor mainly processes the wireless communication. It can be understood that, the modem processor may not be integrated into the processor 180.

The terminal 1200 further includes a power supply 190 such as a battery for powering other elements of the terminal 1200. Preferably, the power supply 1900 is connected to the processor 180 through a power management system. The power management system is used to charge or discharge the power supply 190, and manages the power of the power supply 190, and so on. The power supply 190 may includes any combination of one or more than one direct current (DC) power or alternative current (AC) power, rechargeable battery system, fault detection circuit, converter, or inverter, power state indicator.

The terminal 1200 further may include a camera, a Bluetooth module, and so on. The camera and the Bluetooth module are not shown.

The embodiment provides the terminal 1200. The terminal 1200 can adjust the color matching of the page elements of the web page through embedding the predetermined code with a function of changing the color of the page element into the codes of the web page, after downloading the codes of the web page visited by the user. The color matching of the page element is adjusted to be a new color matching with a low contrast, which is suitable for browsing under the weak light. The terminal solves the problem at business layer, thus makes architecture of the browser clearer. Therefore, it is easier to maintain the browser.

### The Embodiment Five

The embodiment provides a computer readable storage medium. The computer readable storage medium may be the computer readable storage medium of the storage in the above-mentioned embodiments. The computer readable storage medium may be an independent element which is assembled in the computer readable storage medium of the terminal. The computer readable storage medium stores one or more than one programs, which are executed by the one or more than one processors to realize a method for safety protection. The method includes the following steps.

Receiving a uniform resource locator (URL), input by a user, of a web page, and downloading codes of the web page according to the URL.

Embedding a predetermined code into the codes of the web page, wherein the predetermined code has a function of changing colors of page elements of the web page.

Executing the predetermined code to change the colors of the page elements of the web page, to make color contrast between the page elements of the web page be about equal to a predetermined contrast. The web page with the predetermined contrast is suitable for being browsed under the weak light.

Specifically, before embedding a predetermined code into the codes of the web page, the method further includes:

rendering the web page in a page display area of the browser according to the codes of the web page.

Specifically, the step of embedding a predetermined code into the codes of the web page includes:

determining whether a notification indicating that the web page has been rendered is received.

If a notification indicating that the web page has been rendered is received, triggering to execute the operation of the predetermined code.

Specifically, the step of executing the predetermined code to change the colors of the page elements of the web page includes:

obtaining the color attributes of the page elements of the web page one by one, and resetting the color attributes of the page elements of the web page until the all page elements of the web page are been reset.

Specifically, the step of resetting the color attributes of the page elements of the web page includes the following steps.

Obtaining foreground color attributes of the page elements, and setting color values of the foreground color attributes between a value 0XFFFFFF and a value 0x808080.

Obtaining background color attributes of the page elements, and setting color values of the background color attributes between a value 0x000000 and a value 0x808080.

The embodiment provides a computer readable storage medium. The computer readable storage medium can adjust the color matching of the page elements of the web page through embedding the predetermined code with a function of changing the color of the page element into the codes of the web page, after downloading the codes of the web page visited by the user. The color matching of the page element is adjusted to be a new color matching with a low contrast, which is suitable for being browsed under the weak light. The computer readable storage medium solves the problem at business layer, thus makes architecture of the browser clearer. Therefore, it is easier to maintain the browser.

The sequence number of the embodiments is only used to illustrate, not represents merits of the embodiments.

A person having ordinary skills in the art can realize that part or whole of the processes in the methods according to the above embodiments may be implemented by a computer program instructing relevant hardware. The program may be stored in a computer readable storage medium. When executed, the program may execute processes in the above-mentioned embodiments of methods. The storage medium may be a magnetic disk, an optical disk, a Read-Only Memory (ROM), a Random Access Memory (RAM), et al.

The foregoing descriptions are merely exemplary embodiments of the present invention, but not intended to limit the protection scope of the present invention. Any variation or replacement made by persons of ordinary skills in the art without departing from the spirit of the present invention shall fall within the protection scope of the present invention.

What is claimed is:

1. A method for browsing the web under weak light with a mobile terminal browser, comprising:
receiving a uniform resource locator (URL), input by a user, of a web page, and downloading codes of the web page according to the URL;
embedding a predetermined code into the codes of the web page, wherein the predetermined code has a function of changing colors of page elements of the web page;
executing the predetermined code to change the colors of the page elements of the web page, to make color contrast between the page elements of the web page be equal to a predetermined contrast, wherein the web page with the predetermined contrast is suitable for being browsed under the weak light.

2. The method as claimed in claim 1, before embedding a predetermined code into the codes of the web page, the method further comprising:
rendering the web page in a page display area of the browser according to the codes of the web page.

3. The method as claimed in claim 2, wherein the step of embedding a predetermined code into the codes of the web page comprises:
determining whether a notification indicating that the web page has been rendered is received; and
triggering to execute the operation of the predetermined code if a notification indicating that the web page has been rendered is received.

4. The method as claimed in claim 1, wherein the step of executing the predetermined code to change the colors of the page elements of the web page comprises:
obtaining the color attributes of the page elements of the web page one by one, and resetting the color attributes of the page elements of the web page until the all page elements of the web page are been reset.

5. The method as claimed in claim 4, wherein the step of resetting the color attributes of the page elements of the web page comprises:
obtaining foreground color attributes of the page elements, and setting color values of the foreground color attributes between a value 0XFFFFFF and a value 0x808080; and
obtaining background color attributes of the page elements, and setting color values of the background color attributes between a value 0x000000 and a value 0x808080.

6. A device for browsing the web under weak light with a mobile terminal browser, comprising:
a downloading module configured to receive a uniform resource locator (URL), input by a user, of a web page, and download codes of the web page according to the URL;
an embedding module configured to embed a predetermined code into the codes of the web page, wherein the predetermined code has a function of changing colors of page elements of the web page; and
a changing module configured to execute the predetermined code to change the colors of the page elements of the web page, to make color contrast between the page elements of the web page be equal to a predetermined contrast, wherein the web page with the predetermined contrast is suitable for being browsed under the weak light.

7. The device as claimed in claim 6, further comprising:
a rendering module configured to render the web page in a page display area of the browser according to the codes of the web page before the embedding module embeds the predetermined code into the codes of the web page.

8. The device as claimed in claim 7, wherein the embedding module comprises:
a determination unit configured to determine whether a notification indicating that the web page has been rendered is received; and
a triggering unit configured to trigger to execute the predetermined code when the determination unit determines that the web page has been rendered is received.

9. The device as claimed in claim 6, wherein the changing module is further configured to obtain the original color attributes of the page elements of the web page one by one, and reset the original color attributes of the page elements of the web page until the original color attributes of the all page elements of the web page are reset.

10. The device as claimed in claim 9, wherein the changing module further comprises:
an obtaining unit configured to obtain the color attributes of the page elements of the web page one by one;
a first changing unit configured to obtain the foreground color attributes of the page elements, and setting color values of the foreground color attributes between a value 0XFFFFFF and a value 0x808080; and
a second changing unit configured to obtain the background color attributes of the page elements, and setting color values of the background color attributes between a value 0x000000 and a value 0x808080.

11. A terminal, comprising:
a storage;
one or more programs stored in the storage for execution by one or more processors, the one or more programs comprising instructions for:
receiving a uniform resource locator (URL), input by a user, of a web page, and downloading codes of the web page according to the URL;
embedding a predetermined code into the codes of the web page, wherein the predetermined code has a function of changing colors of page elements of the web page;
executing the predetermined code to change the colors of the page elements of the web page, to make color contrast between the page elements of the web page be equal to a predetermined contrast, wherein the web page with the predetermined contrast is suitable for being browsed under the weak light.

12. The terminal as claimed in claim 11, before embedding a predetermined code into the codes of the web page, the terminal further comprising:
rendering the web page in a page display area of the browser according to the codes of the web page.

13. The terminal as claimed in claim 12, wherein the step of embedding a predetermined code into the codes of the web page comprises:
determining whether a notification indicating that the web page has been rendered is received; and
triggering to execute the operation of the predetermined code if a notification indicating that the web page has been rendered is received.

14. The terminal as claimed in claim 11, wherein the step of executing the predetermined code to change the colors of the page elements of the web page comprises:
obtaining the color attributes of the page elements of the web page one by one, and resetting the color attributes of the page elements of the web page until the all page elements of the web page are been reset.

15. The terminal as claimed in claim 14, wherein the step of resetting the color attributes of the page elements of the web page comprises:
obtaining foreground color attributes of the page elements, and setting color values of the foreground color attributes between a value 0XFFFFFF and a value 0x808080; and
obtaining background color attributes of the page elements, and setting color values of the background color attributes between a value 0x000000 and a value 0x808080.
